(19) United States
(12) Patent Application Publication
(10) Pub. No.: US 2013/0036728 A1
(43) Pub. Date: Feb. 14, 2013

(54) PUMP SUCTION CHARGING SYSTEM

(71) Applicants: Gaetan Billaud, Treillieres (FR); Nicolas Gales, Pouldreuzic (FR)

(72) Inventors: Gaetan Billaud, Treillieres (FR); Nicolas Gales, Pouldreuzic (FR)

(73) Assignee: Clark Equipment Company, West Fargo, ND (US)

(21) Appl. No.: 13/642,752

(22) PCT Filed: Apr. 22, 2011
(86) PCT No.: PCT/US2011/033558

§ 371 Date: Oct. 22, 2012

Related U.S. Application Data
(60) Provisional application No. 61/327,275, filed on Apr. 23, 2010.

(51) Int. Cl. F15B 15/18

(52) U.S. Cl. 60/327; 60/486; 60/459; 60/413

(57) ABSTRACT

Disclosed are hydraulic pump systems and pump suction charging systems which reduce or eliminate cavitation in the systems, as well as methods of operating the same and work machines including the same.

### CROSS-REFERENCE TO RELATED APPLICATION

The present application is based on and claims the benefit of U.S. provisional patent application Ser. No. 61/327,275, filed Apr. 23, 2010, the content of which is hereby incorporated by reference in its entirety.

### FIELD

Disclosed embodiments relate to hydraulic systems, such as hydraulic systems of work machines. More particularly, disclosed embodiments relate to hydraulic systems that utilize a pump suction charging system to reduce or eliminate cavitation.

### BACKGROUND

Telehandlers and other work machines typically utilize a hydraulic system including one or more hydraulic pumps to power travel motors, to raise, lower, extend and retract a boom or an arm, to power hydraulic implements, etc. Among other hydraulic circuit components, the hydraulic system includes the one or more hydraulic pumps and a reservoir of hydraulic fluid. The one or more hydraulic pumps provide the hydraulic fluid from the reservoir to one or more parts of the hydraulic circuit to perform the necessary functions.

Cavitation can occur when the volume of fluid demanded by any part of a hydraulic circuit exceeds the volume of fluid being supplied. This can cause the absolute pressure in that part of the circuit to fall below the vapor pressure of the hydraulic fluid, resulting in the formation of vapor bubbles within the fluid. The vapor bubbles implode when compressed. Cavitation can damage hydraulic components and contaminate the hydraulic fluid. In extreme cases, cavitation can result in mechanical failure of pumps and motors.

The discussion above is merely provided for general background information and is not intended to be used as an aid in determining the scope of the claimed subject matter.

### SUMMARY

Disclosed are hydraulic pump arrangements and systems and pump suction charging systems that reduce or eliminate cavitation in the systems, as well as methods of operating the same and work machines including the same.

In one exemplary embodiment, a hydraulic system comprises an actuator, to which hydraulic fluid under pressure is provided. A first pump has a first pump outlet line configured to provide the hydraulic fluid under pressure to the actuator. The first pump has a first pump inlet line in fluid communication with the actuator such that hydraulic fluid returning from the actuator provides a first source of hydraulic fluid to the first pump inlet. A pump suction charging system of the hydraulic system is configured to provide hydraulic fluid under pressure to the first pump inlet to reduce cavitation in the hydraulic system.

In one exemplary embodiment, the pump suction charging system includes a second pump having a second pump outlet in hydraulic communication with the first pump inlet such that the second pump provides a second source of pressurized hydraulic fluid to the first pump inlet. An accumulator of the pump suction charging system is in hydraulic communication with the first pump inlet. The accumulator is capable of maintaining a reserve of hydraulic fluid under pressure, and is configured to provide a third source of pressurized hydraulic fluid to the first pump inlet when hydraulic pressure at the first pump inlet pressure drops below a predetermined value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a left side view of a work machine according to a disclosed embodiment.

FIG. 2-1 is a schematic illustration of a hydraulic pump system with a pump suction charging system according to a first embodiment and showing an actuator control valve in a neutral position.

FIGS. 2-2 and 2-3 are schematic illustrations of the hydraulic pump system shown in FIG. 2-1, showing the actuator control valve in different actuated positions.

FIG. 3 is a schematic illustration of a hydraulic pump system and/or a pump suction charging system according to a second embodiment.

FIG. 4 is a schematic illustration of a hydraulic pump system and/or a pump suction charging system according to a third embodiment.

FIG. 5 is a block diagram illustrating an exemplary method in accordance with disclosed embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

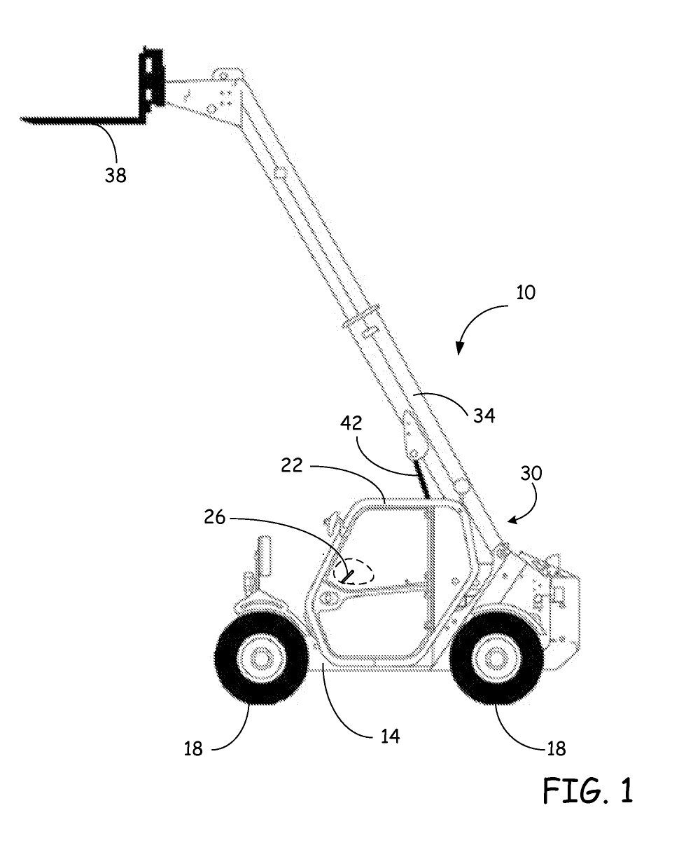

A work machine 10 in the form of a telehandler is shown in FIG. 1 and is provided as an example of a type of work machine in which disclosed embodiments can be utilized. However, the disclosed embodiments can be practiced on other types of work machines such as skid-steer and other wheeled loaders, excavators, utility vehicles, and the like and are not limited to implementation on telehandlers. FIG. 1 illustrates a work machine 10 that includes a frame 14 supported for movement over the ground by front and rear pairs of wheels 18. An operator cab 22 is mounted to the frame 14 and includes operator controls represented generally by reference number 26 for controlling operation of the work machine 10. Operator controls 26 can include any of a variety of different operator control device types, and operator controls 26 generally represents the various operator control types. An engine is mounted to the frame 14 and provides a power source for moving the wheels 18 and other machine functions. The engine, represented generally at reference number 30, is typically positioned on a right side of work machine 10 next to cab 22, and therefore is not visible in FIG. 1. The engine 30 can be an internal combustion engine, an electric engine, or any other suitable power source. A telescopic boom 34 or other types of work arms are pivotally mounted to the frame 14 and include an implement 38 at a distal end thereof. The implement can be any of a wide variety of different types of implements, for example including pallet forks as shown in FIG. 1, buckets, and the like. One or more hydraulic cylinders 42 are coupled between the frame 14 and the boom 34 for raising and lowering the boom 34. One or more other hydraulic cylinders can also be included for performing tilt, boom extension, or other functions. Work machine 10 includes a hydraulic pump system for delivering power to a drive system and for operation of work machine functions such as operation of the boom 34, to name one example.

FIGS. 2-1 through 2-3 illustrate a hydraulic pump system 100 including a pump suction charging system 102 according to a first embodiment. The hydraulic pump system 100 is illustratively used to provide fluid pressure for operating or powering a primary hydraulic system of the work machine 10. For example, system 100 can be used to power systems or components such as the cylinder 42 shown in FIG. 1 and other auxiliary or secondary hydraulic systems. Actuator 104 represents an actuator to which hydraulic power is provided. For example, actuator 104 can be cylinder 42 or other actuators for moving or steering the work machine or for performing work functions. Disclosed system embodiments are of particular usefulness for example when there is at least one cylinder type actuator, though they are not limited to systems which utilize cylinder type actuators, as other types of actuators can be used with disclosed embodiments. While a single actuator 104 is shown, typically multiple actuators will be included on a work machine and actuator 104 is intended to represent one or more such actuators, motors, or other hydraulically powered components. In addition, the hydraulic pump system 100 can be incorporated into a variety of work machines, as discussed above. Work machine 10 in the form of a telehandler is merely exemplary of such a work machine.

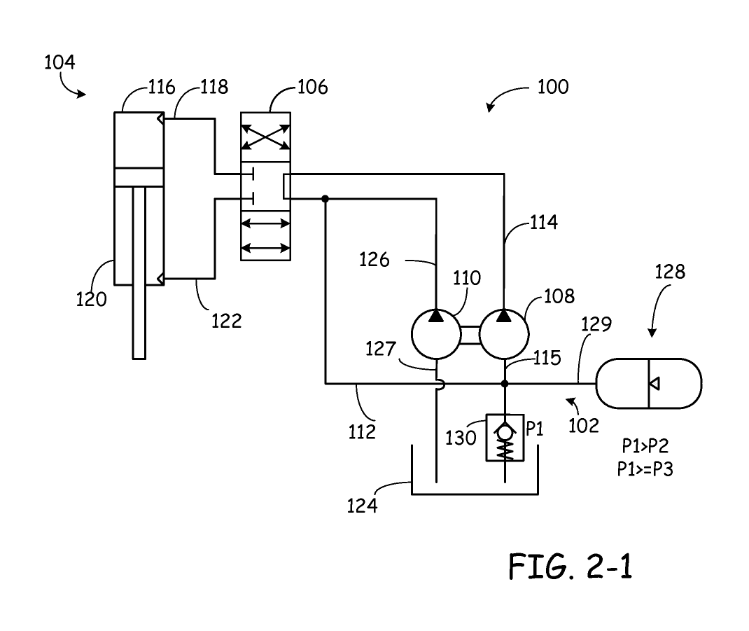

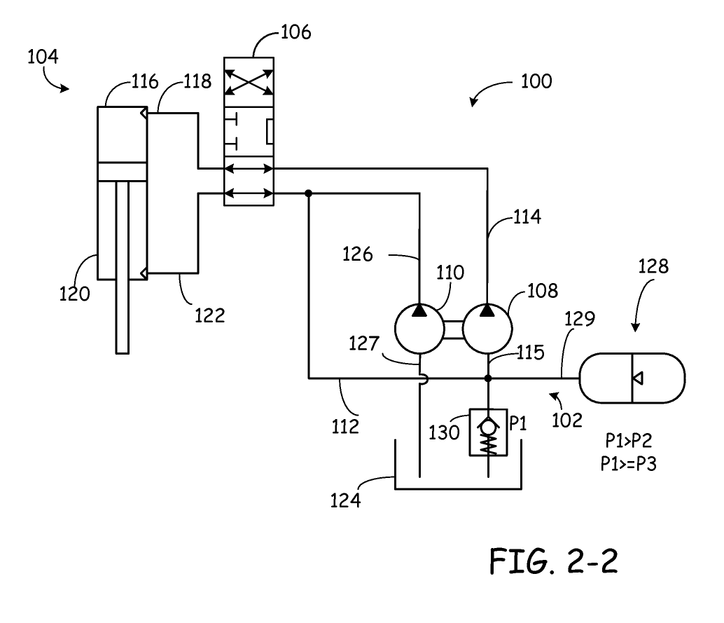

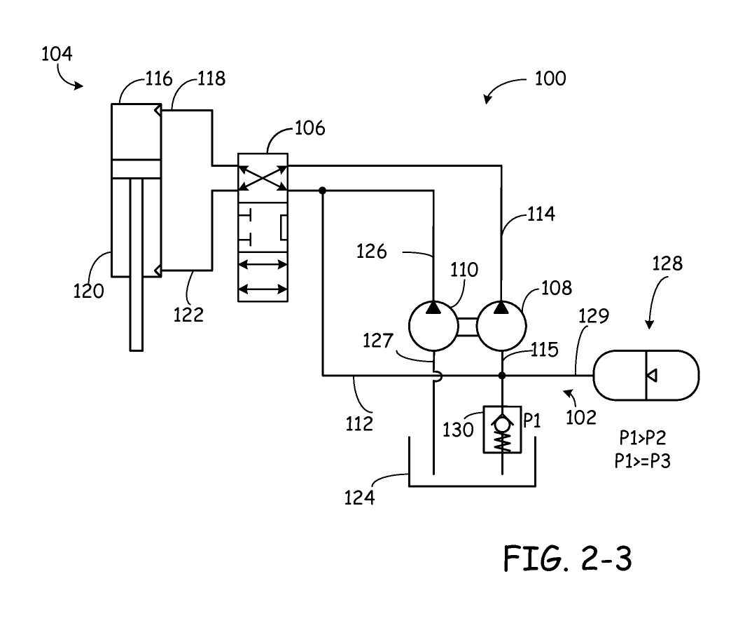

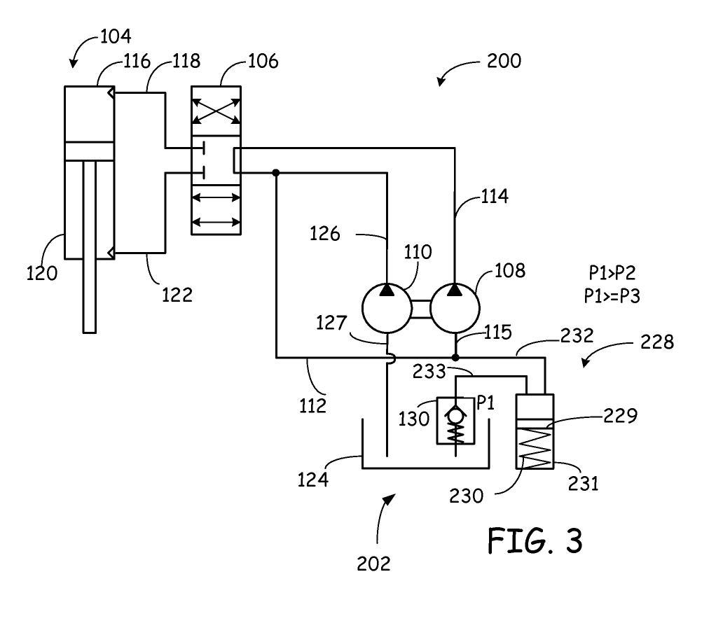

Hydraulic pump system 100 includes an actuator control valve 106, a first pump 108 (also referred to herein as an implement pump), and a second pump 110. First pump 108 is, in some embodiments, a variable displacement, load sense hydraulic pump, although other embodiments may employ fixed displacement pumps. First pump 108 supplies a flow of hydraulic fluid from implement pump suction portions of the circuit (e.g., the portions of the circuit that provide hydraulic fluid to the inlet 115 of first pump 108, including an implement pump inlet line shown in FIG. 2-1) to the actuator 104 through implement pump outlet line 114 and valve 106. When the actuator control valve 106 is in a neutral position (as illustrated in FIG. 2-1), no hydraulic fluid is provided to the actuator 104 and all the implement pump flow through line 114 is provided to the implement pump suction portions of the circuit through a return line 112. When the actuator control valve 106 sends flow through line 118 to cylinder base 116 of actuator 104 to extend the actuator 104 as illustrated in FIG. 2-2, there is a lack of flow to the first pump inlet 115 via the return line 112 because of the difference between flow out of a cylinder rod end 120 and flow into the cylinder base 116. This differential is created because the presence of a rod in the cylinder rod end 120 reduces the overall volume in the rod end side. More fluid is necessarily introduced into the cylinder base 116 to extend the cylinder 104 than is expelled from the cylinder rod end 120. When the actuator control valve 106 sends flow through line 122 to cylinder rod end 120 of actuator 104 as illustrated in FIG. 2-3 to retract the cylinder rod, the opposite is true and there is an excess flow to the implement pump inlet through return line 112.

Second pump 110 provides an output flow of hydraulic fluid at outlet 126, which is coupled directly to the return line 112. The return flow from the second pump 110 is therefore added to the return flow of implement pump 108 through return line 112 so that return line 112 provides flow from two different sources to the inlet 115. Second pump 110 compensates for implement pump losses (volumetric efficiency) and to compensate for a small part of a lack of return flow that can be realized when extending the actuator 104 as discussed above. In some embodiments, second pump 110 is a fixed displacement gear pump. More generally, second pump 110 can be any second pump of the system 100 that pumps or sucks hydraulic oil directly from tank 124 to which pump inlet line 127 is coupled. In some embodiments, second pump 110 is a charge pump dedicated to providing flow to the inlet of other pumps such as first pump 108. Alternatively, second pump 110 can be an implement pump with fixed or variable displacement and the additive flow provided to return line 112 can be fluid returned from another actuator (not shown in any of the figures).

Pump suction charging system 102 of hydraulic pump system 100 includes an accumulator 128, which provides a reserve of oil under pressure. Accumulator 128 has an output 129 that, like return line 112, is in communication with inlet 115 to provide hydraulic fluid to first pump 108. The minimum load pressure of the accumulator 128, that is, the pressure at which the accumulator starts to expand from its minimum volume and accumulate additional hydraulic fluid, is designated as pressure P2. As fluid is introduced into the accumulator, the volume expands until it reaches a maximum volume. The pressure in the accumulator, P3, increases until it reaches P1, the pressure at which the relief valve 130 opens as will be discussed in more detail below. As explained above, when valve 106 directs hydraulic fluid flow to cylinder base 116, there is a lack of flow in return line 112 to the implement pump 108. Second pump 110 supplements this flow by providing hydraulic fluid to return line 112. However, in some cases, the extra flow supplied by the second pump 110 is not enough to compensate for the lack of return flow from the actuator 104 and any actuation devices that might receive flow from the first pump 108. When the flow in return line 112 does not provide sufficient flow to the inlet of implement pump 108, pressure in line 112 drops below pressure P1, the accumulator 128 is capable of supplying pressurized hydraulic fluid to the inlet 115 until the pressure P3 falls below P2. By compensating for this lack of return flow by providing hydraulic fluid under pressure directly to the inlet 115 of pump 108, accumulator 128 helps to prevent cavitation at the inlet 115 of the implement pump 108.

Also included in hydraulic system 100 is relief valve 130, which is in communication with pump inlet 115. Relief valve 130 is configured to open at a pressure P1 and effectively sets a maximum pressure of P1 at the inlet 115 and, by extension, at the accumulator 128. When the pressure at relief valve 130 reaches P1, the relief valve 130 opens so that hydraulic fluid can return to tank 124 through the relief valve 130. Without cylinder movement, the pressure at inlet 115 is equal to pressure P1 because the second pump 110 is capable of providing excess return flow at a pressure above P1. With retraction of the cylinder 104, the pressure at inlet 115 is also pressure P1, because the combined excess flow of the second pump 110 and the differential volume of the cylinder results in sufficient flow to exceed the pressure P1 at relief valve 130.

When the actuator 104 is extending, if differential flow is smaller than the flow from the second pump 110, then the pressure at inlet 115 is at pressure P1. However, if the differential flow is higher than the flow from the second pump 110 when the actuator cylinder is extending, then the pressure at inlet 115 will be between pressure P1 and pressure P2, as long as the accumulator 128 is not fully discharged.

Referring now to FIG. 3, a hydraulic pump system 200 is shown. FIG. 3 illustrates the actuator control valve 106 in the neutral position. While the actuator control valve 106 is not separately illustrated in alternate positions providing hydraulic fluid to the base and rod ends of the actuator 104, it should be understood that valve 106 is movable to the positions shown in FIGS. 2-2 and 2-3 in other disclosed embodiments as well.

In this embodiment, pump suction charging system 202 includes an accumulator 228 in the form of an adjustable reservoir. Adjustable reservoir 228 includes a piston 229 and a spring 230 within a cylinder 231. In this embodiment, the adjustable reservoir accumulator 228 can include two outputs 232 and 233. However, in other embodiments, outputs 232 and 233 can be replaced with a single outlet line 232, and relief valve 130 can be connected directly to inlet 115 of first pump 108. In the illustrated embodiment, output 233 of adjustable reservoir 228 is connected to relief valve 130 discussed above, and output 232 of adjustable reservoir 228 is connected to inlet 115 of first pump 108. The maximum pressure in reservoir 228 is set by the pressure P1 at which the relief valve 130 opens. Pressure P2 is the pressure at which the spring 230 begins to compress. Pressure P3 at the reservoir 228 can vary between 0 and P2 until it is charged, that is, the spring 230 begins to compress, when the pressure P3 can vary between P2 and P1, depending on how much the reservoir 228 is discharged.

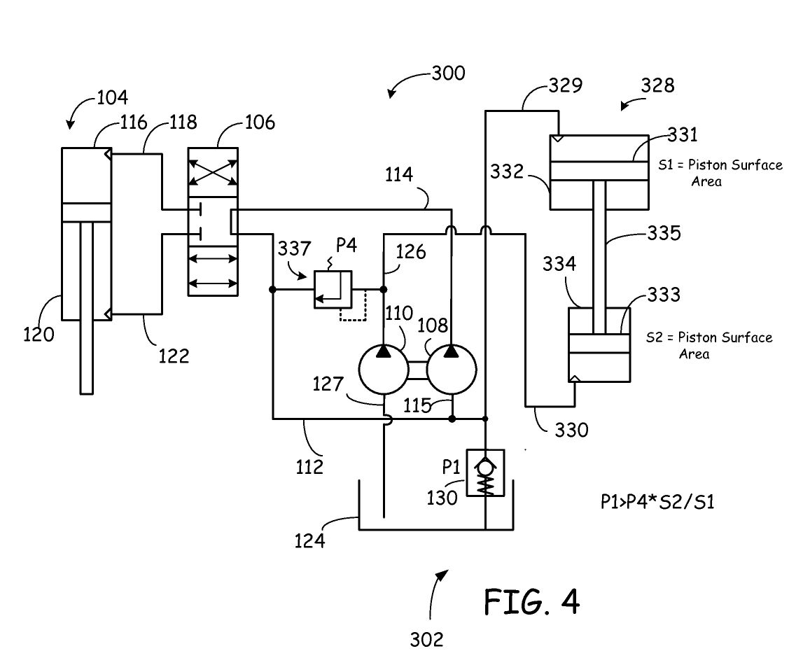

Referring now to FIG. 4, shown is a hydraulic pump system 300 according to another embodiment. In this embodiment, a pump suction charging system 302 includes an accumulator 328 having first and second pistons 331 and 333 that move in unison with one another, that is, they move in the same direction, in first and second cylinders 332 and 334 via a connecting rod 335 coupled to both pistons. Cylinder 332 is coupled via inlet/outlet line 329 directly to check valve 130, return line 112 and pump inlet 115. Cylinder 334 is coupled via inlet/outlet line 330 to outlet 126 of second pump 110. In this embodiment, cylinder 334 and outlet 126 are again coupled to return line 112, but through relief valve 337 in this configuration. Relief valve 337, which can be a hydrostatic transmission charge pump relief valve, has a relief pressure value of P4. The relief valve 337 maintains pressure P4 at a constant pressure value, for example 30 bar, which becomes the hydrostatic transmission charge pressure value.

In hydraulic pump system 300, instead of including a spring in the accumulator 328, pressure P4 is continuously supplied to cylinder 334 with piston 333 having a piston surface area S2. In communication with this cylinder 334 is another cylinder 332 with piston 331 having a piston surface area S1. The resulting pressure generated by this second cylinder 332 is equal to P4*S2/S1. With S2 being much smaller than S1, a relatively low pressure is achieved in cylinder 332, which is advantageous for suction pump charging. P4*S2/S1 must be lower than P1 to facilitate charging of the accumulator 328 when no movement or retraction of the actuator 104 is occurring.

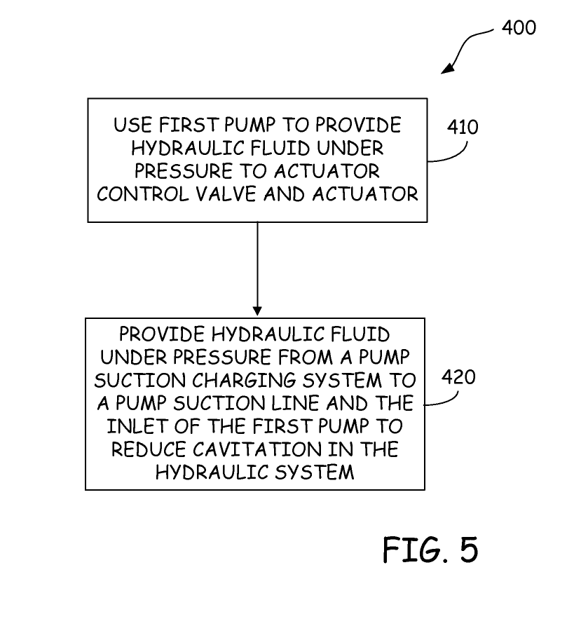

Method embodiments include, by way of example, operation of hydraulic systems described above with reference to the embodiments illustrated in FIGS. 2-1 through 2-3, 3, and 4. FIG. 5 is a block diagram that illustrates such a method 400 provided as one illustrative embodiment. Disclosed methods are not limited, however, to the specific examples of hydraulic systems discussed above.

Referring now more specifically to FIG. 5 in view of the embodiments of hydraulic systems discussed above, block 410 of method 400 includes using a first pump to provide hydraulic fluid under pressure to an actuator. As an example, pump 108, which has a first pump outlet line 114 coupled to the actuator control valve 106 and a first pump inlet line 115 coupled to a return line 112, provides the hydraulic fluid under pressure to the actuator 104 via actuator control valve 106. At block 420, hydraulic fluid is provided under pressure from a pump suction charging system (e.g., 102, 202, 302) to the return line 112 and the first pump inlet 115 to reduce cavitation in the hydraulic system.

In exemplary embodiments, providing hydraulic fluid under pressure from the pump suction charging system to the first pump inlet 115 comprises providing hydraulic fluid under pressure to the inlet 115 from an accumulator (128, 228, 328) coupled to the inlet 115 when the pressure at first pump inlet 115 drops below a predetermined value. In some embodiments, pressurized hydraulic fluid is provided from a second pump 110 having a second pump inlet 127 coupled to tank 124 and a second pump outlet 126 coupled to the return line 112 such that the second pump 110 causes pressurized hydraulic fluid to be provided to the first pump inlet 115.

In exemplary embodiments, providing hydraulic fluid under pressure from the pump suction charging system further includes storing hydraulic fluid under pressure in the accumulator when a charge pressure at the inlet to the implement pump exceeds a minimum charge pressure P2 of the accumulator and until a pressure of hydraulic fluid maintained by the accumulator reaches a maximum load pressure P1 of the accumulator.

In some exemplary embodiments, disclosed methods include using a relief valve 130 coupled between the accumulator and tank to set a maximum charge pressure P1 for hydraulic fluid charging the accumulator, such that P1 is greater than P2.

In some exemplary embodiments, providing hydraulic fluid under pressure to the pump suction line from the accumulator includes providing the hydraulic fluid under pressure from an adjustable reservoir.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, in various embodiments, different types of work machines can include the disclosed hydraulic systems. Other examples of modifications of the disclosed concepts are also possible, without departing from the scope of the disclosed concepts.

What is claimed is:

1. A hydraulic system comprising:
an actuator to which hydraulic fluid under pressure is provided;
a first pump having a first pump outlet configured to provide the hydraulic fluid under pressure to the actuator, the first pump having a first pump inlet in fluid communication with the actuator such that hydraulic fluid returning from the actuator provides a first source of hydraulic fluid to the first pump inlet; and
a pump suction charging system configured to provide hydraulic fluid under pressure to the first pump inlet to reduce cavitation in the hydraulic system, the pump suction charging system comprising:
a second pump having a second pump outlet in hydraulic communication with the first pump inlet such that the second pump provides a second source of pressurized hydraulic fluid to the first pump inlet; and
an accumulator in hydraulic communication with the first pump inlet and capable of maintaining a reserve of hydraulic fluid under pressure, the accumulator configured to provide a third source of pressurized hydraulic fluid to the first pump inlet when hydraulic pressure at the first pump inlet drops below a predetermined value.

2. The hydraulic system of claim 1, wherein a volume of the accumulator expands to receive hydraulic fluid under pressure when the hydraulic pressure at the first pump inlet exceeds a first pressure level P2 and until a maximum volume of the accumulator is reached.

3. The hydraulic system of claim 2, and further comprising a relief valve in communication with the first pump inlet, the relief valve configured to set a maximum hydraulic fluid pressure P1 at the first pump inlet.

4. The hydraulic system of claim 1 and further comprising an actuator control valve positioned between the first pump outlet and the actuator.

5. The hydraulic system of claim 4, wherein the control valve has a neutral position, which prevents flow from the first pump outlet from being provided to the actuator and directs flow from the first pump outlet to the first pump inlet.

6. The hydraulic system of claim 1, wherein the accumulator comprises an adjustable reservoir.

7. The hydraulic system of claim 6, wherein the adjustable reservoir comprises a reservoir cylinder, a reservoir piston, and a spring positioned within the reservoir cylinder.

8. The hydraulic system of claim 1, wherein the accumulator has first and second ports and further comprising a first relief valve in communication with the first pump inlet, the first relief valve setting a maximum pressure P1 at the first pump inlet, wherein the second pump outlet is in fluid communication with the first port of the accumulator and the second port of the accumulator is in communication with the first pump inlet, and wherein the accumulator further includes:
a first cylinder with a first piston having a first piston surface area S1 positioned therein;
a second cylinder with a second piston having a second piston surface area S2 positioned therein, and wherein the first piston surface area and the second piston surface area are not equal; and
a connecting rod coupled to each of the first and second pistons such that the first and second pistons move in unison with one another in the first and second cylinders.

9. The hydraulic system of claim 8, wherein the first cylinder is coupled in fluid communication with the first pump inlet and the second cylinder is coupled in fluid communication with the second pump outlet.

10. The hydraulic system of claim 9, wherein the second pump outlet and the second cylinder of the accumulator are coupled in fluid communication to the first pump inlet through a second relief valve having a relief pressure P4, wherein a pressure of hydraulic fluid provided to the first pump inlet by the second cylinder of the accumulator is equal to P4*S2/S1, and wherein P1 is greater than P4*S2/S1.

11. A method of reducing cavitation in a hydraulic system that provides pressurized hydraulic fluid to an actuator, comprising:
using a first pump having a first pump outlet in fluid communication with the actuator to provide pressurized fluid to the actuator and providing a fluid path between the actuator and a first pump inlet to provide a first source of pressurized hydraulic fluid to the first pump inlet; and
providing additional hydraulic fluid under pressure from a pump suction charging system to the first pump inlet to reduce cavitation in the hydraulic system including from an accumulator that is in communication with the first pump inlet.

12. The method of claim 11, wherein providing additional hydraulic fluid under pressure from the pump suction charging system to the first pump inlet further comprises providing pressurized hydraulic fluid from a second pump to the first pump inlet.

13. The method of claim 12, and further comprising causing a volume of the accumulator to expand and store hydraulic fluid under pressure in the accumulator when the hydraulic pressure at the first pump inlet exceeds a minimum pressure setting of the accumulator and until a maximum volume of hydraulic fluid capable of being held by the accumulator is reached.

14. The method of claim 13, and further comprising providing a relief valve in communication with the first pump to set a maximum pressure at the first pump inlet.

15. The method of claim 11, wherein providing hydraulic fluid under pressure to the first pump inlet from the accumulator comprises providing the hydraulic fluid under pressure from an adjustable reservoir.
